(19) United States
(12) Patent Application Publication
(10) Pub. No.: US 2007/0290018 A1
(43) Pub. Date: Dec. 20, 2007

(54) TAPE DISPENSING AND CUTTING DEVICE

(76) Inventor: Edward Matechuk, Surrrey (CA)

Correspondence Address: STANDLEY LAW GROUP LLP, 495 METRO PLACE SOUTH, SUITE 210, DUBLIN, OH, 43017, US

(21) Appl. No.: 11/764,831

(22) Filed: Jun. 19, 2007

Related U.S. Application Data
(60) Provisional application No. 60/805,142, filed on Jun. 19, 2006.

(51) Int. Cl. B26F 3/00; B65H 35/10

(52) U.S. Cl. 225/1; 225/49; 225/56; 225/66

(57) ABSTRACT

A rolled material, such as pressure adhesive tape, dispenser that provides for one-handed operation in a forward or backward direction, and applies the rolled material to a surface while being able to remain in contact with a perpendicular surface. The dispenser has a body and a spool to hold a rolled material. The body also has a cylindrical handle, cutting elements, and spindles. The spindles hold the spool, and the payed out material application wheels. The payed material is thread around the application wheels and applied to a surface. The cylindrical handle allows the body to be rotated so that the cutting elements can cut the desired length rolled material. The spool and application wheels have a covering of friction reducing material allowing the device to make contact with a surface perpendicular to the application surface in a safe manner.

### CROSS-REFERENCE TO RELATED APPLICATIONS

This application is a non-provisional of U.S. provisional patent application 60/805,142, filed Jun. 19, 2006, which is incorporated by reference as if fully recited herein.

### FIELD OF THE INVENTION

The present invention relates to an apparatus for dispensing rolled material having a pressure adhesive. In particular, the invention relates to a hand-operated rolled material dispensing apparatus for applying rolled material to a variety of surfaces, such as walls, windows, vehicles and the like in preparation for painting.

### BACKGROUND OF THE INVENTION

Rolled material dispensers are known. Typically a rolled material dispenser comprises a dispenser structure which rotatably supports a rolled material. After the desired amount of rolled material is dispensed a cutting element, located on the dispenser, is placed in cutting engagement with the payed out material and the dispenser is manipulated to cut the payed out material. In prior art rolled material dispensers, a twisting, cutting action is used to cut the payed out material. This twisting action is required in order to increase the pressure on the payed out material at one edge along the width of the payed out material to make the cutting operation easier. It is desirable to provide a more versatile rolled material dispenser whereby the payed out material cutting action can be easily done without twisting either the payed out material or the rolled material dispensing device.

Prior art rolled material dispensers are provided with a single cutting means, which restricts both the direction in which the rolled material can be dispensed, as well as the ease of use of the rolled material dispenser by both right and left-handed operators. Accordingly, it is desirable to provide a rolled material dispenser that can dispense rolled material in any direction and can be easily operated by both right and left-handed operators.

### SUMMARY OF THE INVENTION

The rolled material dispenser of the present invention is a hand-operated one-piece, plastic molded dispenser. The rolled material dispenser comprises a body having a cylindrical hand grip and a first spindle. The first spindle securely and rotatably receives a spool. The spool is sized to receive standard sized rolled material and can rotate freely in either direction to payout the rolled material depending on the application direction desired. Two more spindles also extend from the body, each rotatably receiving an application wheel. Each application wheel has a cylindrical shape having a slightly raised washer-like element circumferentially attached at each end thereof.

Two cutting elements are integrally molded on either side of two application wheels that are provided for guiding the payed out material during application. The cutting elements have a specialized angled orientation to be described later which permits a simple rotation of the dispenser to cut the payed out material, as opposed to a twisting action. During the cutting operation only a few teeth engage the payed out material at any one time, thereby increasing the pressure applied to the payed out material, without the need to twist the payed out material or the rolled material dispenser.

In operation, the rolled material is loaded onto the spool, to payout in the selected direction, right or left. The raised rubber rings on the application wheels allow the operator to apply pressure along the edge of the payed out material during the dispensing operation.

The two cutting elements are offset from the plane of the payed out material so that they do not engage the payed out material during the dispensing operation. After the desired amount of payed out material has been dispensed the operator may rotate the rolled material dispenser about its horizontal axis until the cutting elements engage the payed out material. At the point of engagement with the payed out material, the cutting elements are oriented perpendicular to the payed out material, producing a straight cut.

The two cutting elements are positioned symmetrically about the vertical axis of the rolled material dispenser. This symmetrical configuration enables the dispensing of the rolled material to be performed in both directions, depending on need. Furthermore, the symmetrical configuration enables both right and left-hand operators to operate the rolled material dispenser with ease.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a perspective view of the rolled material dispenser according to the present invention, showing the exterior features.

FIG. 2 is another perspective view of the rolled material dispenser showing the interior features.

FIG. 3 is yet another perspective view of the rolled material dispenser showing a roll of rolled material loaded on the dispenser and ready for operation.

FIG. 4 is a side view of the rolled material dispenser illustrating the cutting operation.

FIG. 5 is a front view of the rolled material dispenser placed against an application surface and a perpendicularly intersecting surface.

FIG. 6 is a side view of the rolled material dispenser illustrating the use of flanges as a means for applying the payed out rolled material.

FIG. 7 is a side view of the rolled material dispenser illustrating the use of a single application wheel for applying the payed out rolled material.

### DESCRIPTION OF PREFERRED EMBODIMENTS

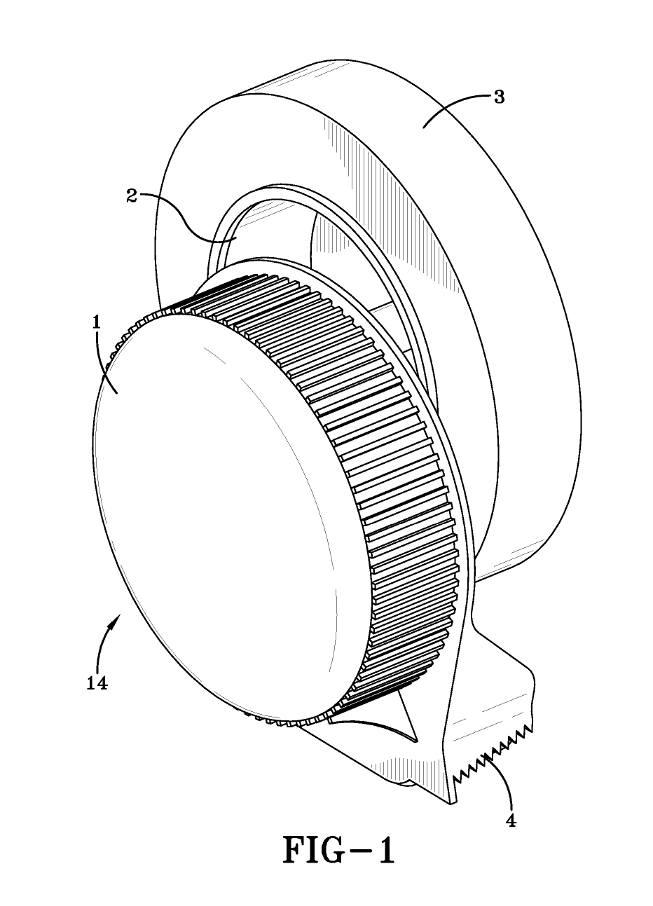

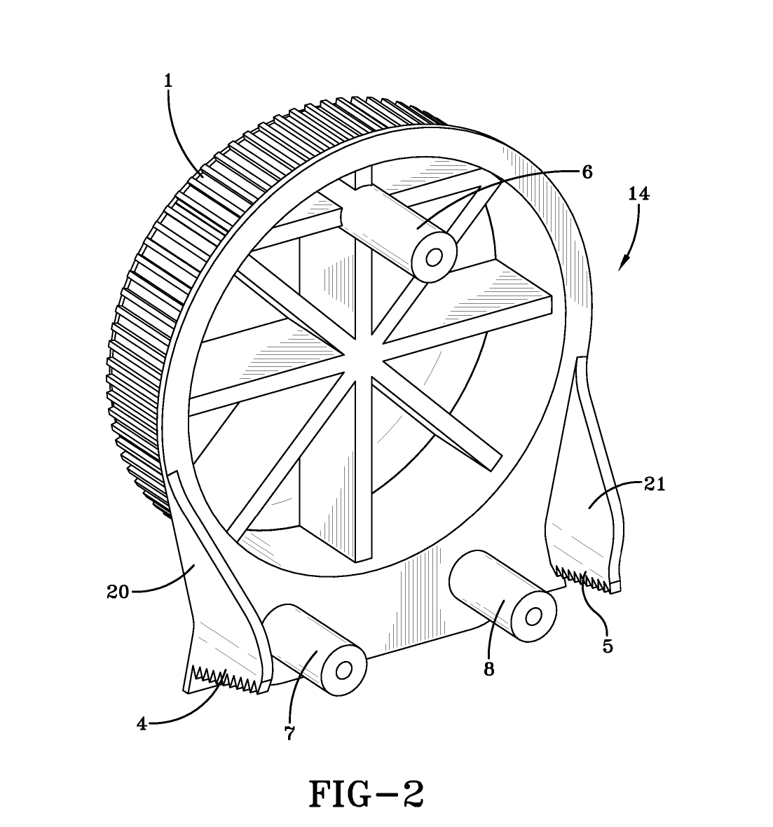

Referring now to FIG. 1 and FIG. 2, the device body 14 has a cylindrical hand grip 1 and a first spindle 6. The first spindle 6 securely and rotatably receives a spool 2. A rolled material 3 is mounted on the spool 2 and can rotate freely in both directions. The exterior surface of the cylindrical hand grip 1 is ribbed to permit better gripping of the device during operation. One of two cutting elements 4 is shown.

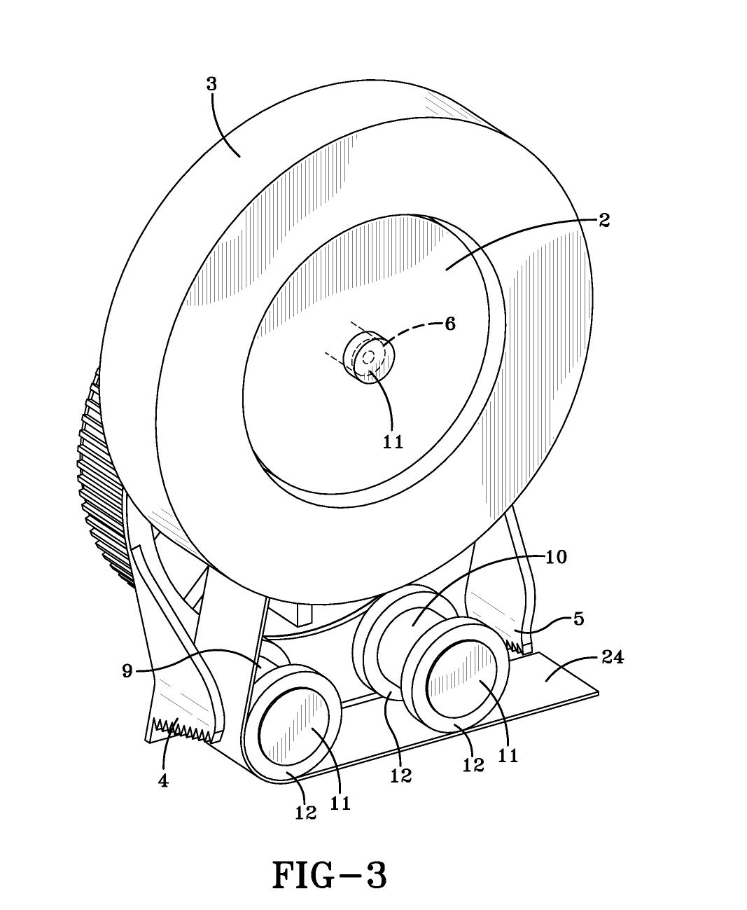

Referring to FIG. 2, a second and third spindle 7 and 8 are shown, each rotatably and securely receive application wheels 9 and 10 (shown in FIG. 3). FIG. 2 shows as well two flanges 20 and 21 located symmetrically on either side of the application wheels 9 and 10 (shown in FIG. 3), each flange 20 and 21 has a cutting element 4 and 5, located at the end of the flanges 20 and 21. The rolled material dispenser comprising the cylindrical hand grip 1, spindles 6, 7 and 8, flanges 20 and 21, and cutting elements 4 and 5, is a one-piece plastic molding.

Referring to FIG. 3 the rolled material dispenser is shown having a rolled material 3 fitted thereon, ready for dispensing. As can be seen, one end of the payed out material 24 is passed along the under side of the application wheels 9 and 10 and remains on a vertical plane to the rolled material 3 at all times.

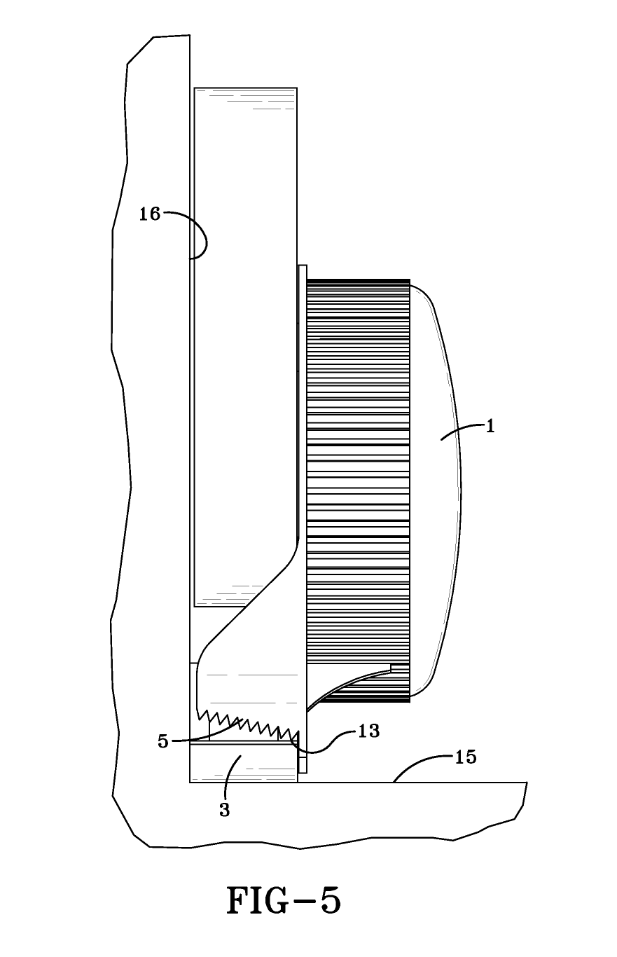

A means for sliding along a surface 11 may be used on the outer most coplanar surfaces of the spool 2 and application wheels 9 and 10. The means for sliding along a surface 11 may be a cloth-like material or other material that reduces friction and prevents damage. This enables the rolled material dispenser to be operated in close proximity or even in contact with a flat surface, without damaging the adjacent or abutting perpendicular surface. An example of such an application is the dispensing of rolled material 3 in the corner formed by two walls. The rolled material dispenser may be in engaged with an application surface 15 (shown in FIG. 5) applying the payed out material 24, while the means for sliding along a surface 11 is in contact with an adjacent perpendicular wall 16 (shown in FIG. 5).

As well, the coplanar feature of the rolled material dispenser permits easy loading of the rolled material 3. The loading operation consists of placing a rolled material 3 in partial circumferential engagement over the spool 2. Thereafter, the rolled material dispenser is manipulated to press the rolled material 3 against a flat surface, which loads the rolled material 3 onto the spool 2, all elements are coplanar. In this manner the rolled material 3 is loaded correctly and remains in the correct position.

The two application wheels 9 and 10 are plastic cylinders. Raised rubber washers 12 are circumferentially attached over the ends of application wheels 9 and 10. During the dispensing operation the payed out material 24 travels under the application wheels 9 and 10 with the non-adhesive side in substantial contact with the rubber washers 12. The pressure adhesive side of the payed out material 24 is in contact with the surface 16 for application. The function of the rubber washers 12 is to enable the operator to apply pressure to the rolled material dispenser such that only the outside edges of the payed out material 24 make adhesive contact with the surface. This provides the advantage of eliminating the risk of damaging the painted surface thereunder during removal of the tape, which is likely if the entire rolled material 3 is adhesively applied to the surface. Another advantage is that the payed out material 24 can be more easily removed after application.

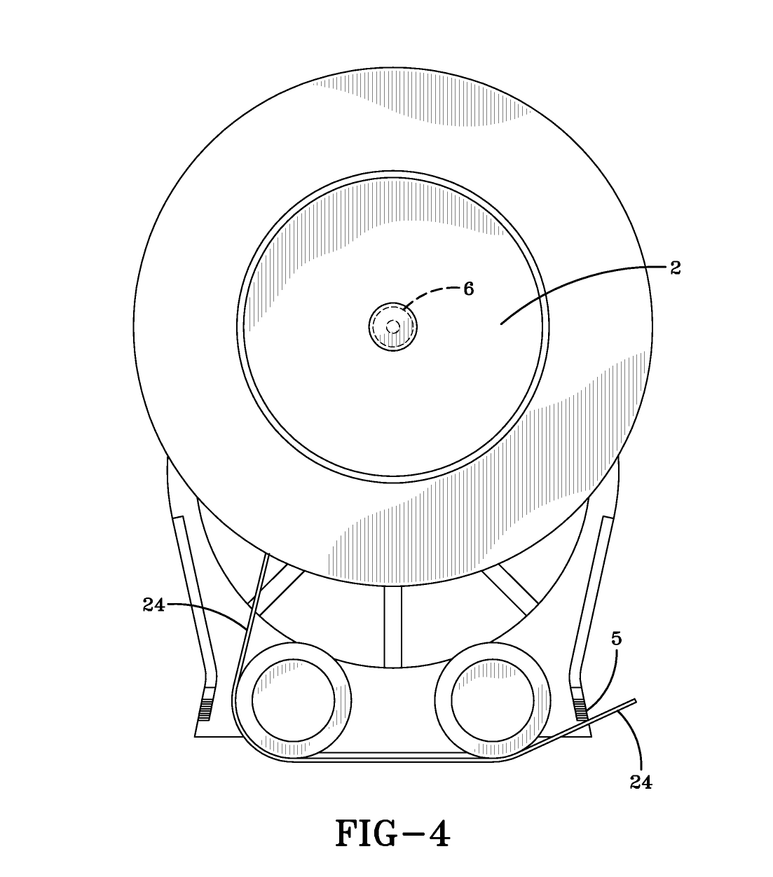

The two cutting elements 4 and 5 are aligned substantially vertical to engage the horizontal plane of the payed out material 24, as can be seen in FIG. 3 and FIG. 4. The cutting elements 4 and 5 are angled downwardly towards the body 14, so that only one end thereof comes into contact with the payed out material 24 when the operator engages the cutting action. It can also be appreciated from FIGS. 3 and 4 that the payed out material 24 can travel under the application wheels 9 and 10 in both directions, depending on the selected direction of the rolled material 3.

Referring now to FIG. 4, the cutting element 5 is used to sever the payed out material 24 from the remainder of the rolled material 3. The contact between the cutting element 5 and the payed out material 24 is achieved by rotating the rolled material dispenser about its horizontal axis, in the longitudinal direction of the payed out material 24. At the point where the cutting element 5 engages the payed out material 24 (hereafter the engagement point 13), the angle between the cutting element 5 and the payed out material 24 is approximately 90 degrees. This enables the cutting operation to produce a straight cut.

Referring now to FIG. 5 the angled orientation of the cutting element 5 is shown. During the cutting operation the operator rotates the cylindrical hand grip 1 so that the cutting element 5 engages the payed out rolled material 3. Due to the angled orientation of the cutting element 5 with respect to the plane of the payed out material 24, only a few teeth of the cutting element 5 first engage the payed out material 24. This increases the pressure applied to the payed out material 24 at the engagement point 13, making the cutting operation easier and eliminating the need to twist the rolled material or the rolled material dispenser. As the cylindrical hand grip 1 is further rotated about its horizontal axis, the cut progresses along the width of the payed out material 24, from one edge to the other. The preferred angle of the blade is between 10 and 25 degrees. The width of the cutting elements 4 and 5 is such that the rolled material dispenser can accommodate standard width tapes commercially available.

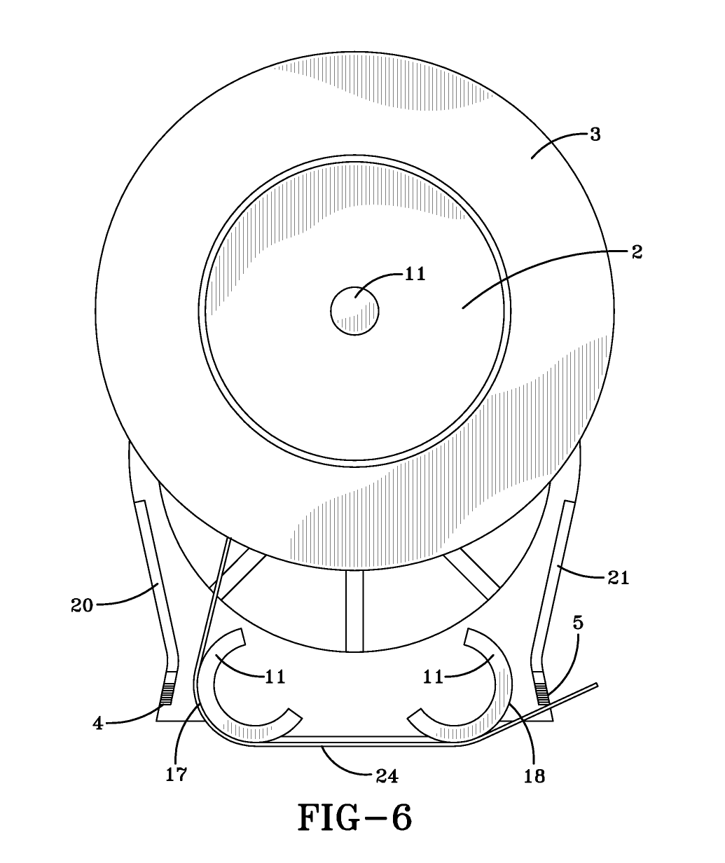

FIG. 6 shows an alternate embodiment, in this embodiment the application wheels 9 and 10 are replaced by curved application flanges 17 and 18. The payed out material 24 is thread under the application flanges 17 and 18 so that the non-adhesive portion of the payed out material 24 is in contact with the application flanges 17 and 18. The application flanges 17 and 18 may have a raised inner and outer edge (not shown in the Figures) to apply the payed out material 24. The application flanges 17 and 18 and the spool 2 are coplanar. A means for sliding along a surface 11 may be used on the outer most coplanar edges of the spool 2 and the application flanges 17 and 18. The means for sliding along a surface 11 may be a cloth-like material or other material that reduces friction and prevents damage.

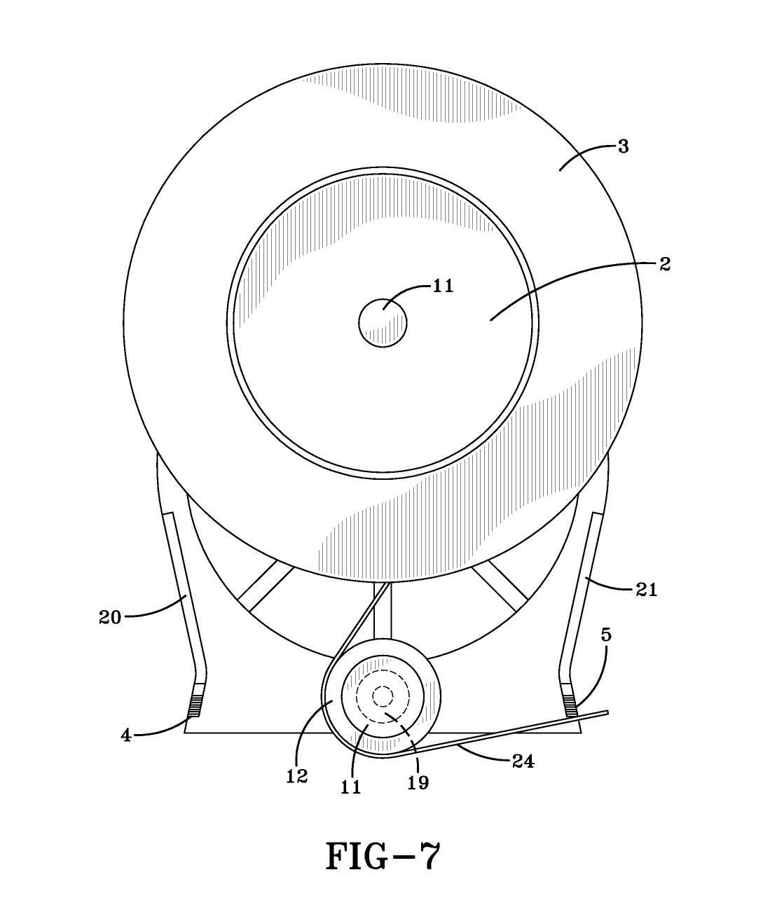

FIG. 7 shows another embodiment, in this embodiment, the second and third spindles 6 and 7 are replaced with a single second spindle (not shown in the Figures). This second spindle is oriented in the center lower portion of the body 14, and is adapted to rotatably receive an application wheel 19. The single application wheel 19 has raised washers 12 circumferentially attached to its inner and outer edge to allow for application of the payed out material 24. The payed out material 24 may be thread around either side of the application wheel 19 to provide contact with the non-adhesive portion of the payed out material 24 and the single application wheel 19. A means for sliding along a surface 11 may be used on the outer most coplanar edges of the spool 2 and the application wheel 19. The means for sliding along a surface 11 may be a cloth-like material or other material that reduces friction and prevents damage.

In all embodiments, the rolled material 3 may be a double sided pressure adhesive rolled material. The double sided rolled material may be thread in the same manner as the payed out material 24 above, with the release strip remaining intact until after application.

Other advantages, which are inherent to the structure, are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed is:

1. A device for dispensing a rolled material 3 from a spool 2 onto a surface 16, the device comprising:
a body 14, having first and second side surfaces and a lower portion;
a cylindrical hand grip 1, extending from the first side surface;
a first spindle 6, extending from the second side surface, adapted for removably receiving the spool 2 of rolled material 3; and
a means for applying, onto the surface, the material as payed out.

2. The device of claim 1 wherein the means for applying further comprises:
a second and third spindle 7 and 8 each extending from the second side surface and adapted to rotatably receive an application wheel 9 and 10.

3. The device of claim 1 wherein the cylindrical hand grip 1 further comprises:
a ribbing 22 circumferentially applied to a portion perpendicular to the first side surface.

4. The device of claim 1 further comprises:
a first and second flange 20 and 21 extending from the opposed ends of the lower portion of the second side surface; and
a first and second cutting element 4 and 5 located at the ends of the flanges.

5. The device of claim 4 wherein the first and second cutting elements further comprises:
an edge angled downwardly towards the body 14 and aligned substantially vertical to engage the horizontal plane of the payed out material 24.

6. The device of claim 5 wherein the body 14, cylindrical hand grip 1, first spindle 6, second spindle 7, third spindle 8, cutting elements 4 and 5 and flanges 20 and 21 are of a one-piece plastic molding.

7. The device of claim 6 wherein the first spindle 6, second spindle 6, third spindle 7, and cylindrical hand grip 1 have parallel axes.

8. The device of claim 2 wherein the application wheels 9 and 10 further comprises:
a cylindrical shape; and
circumferentially received washers 12 around the inner and outer edge of the application wheels 9 and 10.

9. The device in claim 8 wherein the application wheels 9 and 10 and the spool 2 are in a vertical coplanar configuration.

10. The device in claim 1 wherein the means for applying further comprises:
a first and second application flange 17 and 18 extending from the second side surface of the body 14;
a raised inner and outer edge of the application flanges 17 and 18;
a vertical coplanar configuration with the spool 2; and
a means for sliding along a surface 11.

11. The device in claim 1 wherein the means for applying further comprises:
a second spindle adapted to rotatably receive an application wheel 19 extending from the second side surface of the body 14.

12. The device in claim 11 wherein the application wheel 19 further comprises:
a cylindrical shape; and
circumferentially receives washers around the inner and outer edge of the application wheel 19; and
the application wheel 19 and the spool 2 are in a coplanar configuration.

13. The device in claim 8 wherein the application wheels 9 and 10 and the spool 2 further comprising:
a means for sliding along a surface 11.

14. A method of applying to a surface a rolled material having a pressure sensitive adhesive on one side thereof, comprising the steps of:
providing a device according to claim 4, the rolled material mounted on the device;
threading a payed out end of the rolled material around the applying means;
positioning the device, using the cylindrical hand grip, to engage the payed out end with the surface;
moving the device along the surface, using the cylindrical hand grip, applying sufficient pressure to adhere the payed out material to the surface; and
cutting the payed out material after applying a desired length thereof on the surface, by rotating the device around the axis of the cylindrical hand grip to bring the cutting elements into contact with the payed out material.

15. The method of claim 14, wherein:
the step of moving the device along the surface is achieved while maintaining the device in contact with a second surface that perpendicularly intersects the surface.
